(19) United States
(12) Patent Application Publication
(10) Pub. No.: US 2022/0290529 A1
(43) Pub. Date: Sep. 15, 2022

(54) GAS FLOW RATE ANALYSIS AND PREDICTION METHOD FOR WELLHEAD CHOKE OF GAS WELL BASED ON GAUSSIAN PROCESS REGRESSION

(71) Applicant: Southwest Petroleum University, Chengdu (CN)

(72) Inventors: Youshi JIANG, Chengdu (CN); Yan KOU, Chengdu (CN); Yongming LI, Chengdu (CN); Jing JIA, Chengdu (CN); Jinzhou ZHAO, Chengdu (CN)

(73) Assignee: Southwest Petroleum University, Chengdu (CN)

(21) Appl. No.: 17/676,264

(22) Filed: Feb. 21, 2022

(30) Foreign Application Priority Data
Mar. 15, 2021 (CN) 202110274038.8

(51) Int. Cl. E21B 34/02; E21B 49/08; E21B 47/10

(52) U.S. Cl. CPC E21B 34/025; E21B 49/0875; E21B 47/10; E21B 2200/02; E21B 2200/20; E21B 2200/22

(57) ABSTRACT

The present invention discloses a gas flow rate analysis and prediction method for wellhead choke of gas well based on Gaussian process regression, comprising the following steps of Step 1) acquiring basic data of the wellhead choke on site, Step 2) selecting a kernel function, Step 3) calculating a covariance matrix, Step 4) testing the Gaussian process regression model with the test data sample to calculate a prediction deviation, Step 5) selecting different kernel functions, repeating Steps 2-4, comparing prediction deviations of the different kernel functions, and Step 6) analyzing and predicting the gas flow rate of the wellhead choke of the gas well to be tested. According to the method, the data of the wellhead choke of the gas well can be processed effectively, and the gas flow rate can be predicted accurately under the condition that there is gas-liquid flow rate in the wellhead choke.

### CROSS-REFERENCE TO RELATED APPLICATIONS

The application claims priority to Chinese patent application No. 202110274038.8, filed on Mar. 15, 2021, the entire contents of which are incorporated herein by reference.

### TECHNICAL FIELD

The present invention pertains to the technical field of gas reservoir development, in particular to a gas flow rate analysis and prediction method for wellhead choke of gas well based on Gaussian process regression.

### BACKGROUND

With the increasing energy demand in China, shale gas, as an effective supplement to unconventional oil and gas resources, has been spotlighted and considered as a crucial element to guarantee the energy supply in China. In the shale gas production system, by reasonably changing the size of the wellhead choke of shale gas well to limit the gas flow through it, the wellhead choke plays an important role in avoidance of over-rapid production of gas wells, prevention against gas and water coning, sand flow rate control, potential pipe damage minimization. Therefore, the accurate prediction of choke gas flow rate can not only effectively safeguard gas well production, but also improve production efficiency.

During the production of shale gas wells, there is usually gas-liquid two-phase flow in the wellhead choke. If there is gas-liquid two-phase flow, the performance characteristics of the choke are complex, making it difficult to accurately predict the choke flow rate and select a reasonable wellhead choke size. Current methods for predicting choke flow rate are mainly empirical methods, such as Gilbert-type correlation (GC), artificial neural network (ANN) and support vector machine (SVM), and theoretical methods based on mass, momentum and energy balance equations. However, it is obvious that the theoretical model is complicated and inconvenient for field application. The empirical approach is to analyze field data, identify key factors affecting choke flow rate, then establish a model, and predict the choke flow rate. There is low accuracy in the results of choke flow rate prediction with traditional GC method, so that previous methods with higher prediction accuracy such as ANN and SVM have been proposed. At present, scholars are still continuing to explore new methods for better prediction effect.

### SUMMARY

In view of the above problems, the present invention aims to provide a gas flow rate analysis and prediction method for wellhead choke of gas well based on Gaussian process regression, which is featured by easier implementation and higher accuracy, and can make up for the shortcomings of choke flow rate prediction methods in prior art.

The technical solution of the present invention is described as follows:

A gas flow rate analysis and prediction method for wellhead choke of gas well based on Gaussian process regression, comprising the following steps:

Step 1: Acquire basic data of the wellhead choke on site and dividing them into training data samples and test data samples;

Preferably, the basic data of the wellhead choke on site includes gas flow rate at different moments, produced liquid-gas ratio, choke diameter, wellhead temperature, and wellhead oil pressure. The wellhead temperature can be obtained with a thermometer, and the wellhead oil pressure can be obtained with a pressure gauge.

Preferably, the gas flow rate refers to the volume flow rate of the gas flowing through the wellhead choke under standard conditions; the produced liquid-gas ratio refers to the ratio of the liquid flow rate to the volume flow rate of the gas flowing through the wellhead choke under standard conditions.

Preferably, the gas flow rate, produced liquid-gas ratio, choke diameter, wellhead temperature and wellhead oil pressure at each moment are divided into one group; the number of groups of the training data samples is greater than that of the test data samples.

Preferably, the ratio of the number of sample groups of training data to the number of sample groups of test data is 6-9:4-1.

Step 2: Select a kernel function and assume an iterative initial value of an undetermined parameter of the kernel function;

Preferably, the kernel function refers to any one of exponential kernel function, square exponential kernel function, quadratic rational kernel function, and Matérn kernel function;

The exponential kernel function is:

$${k}_{Ex} ( x , {x}^{′} ) = {σ}^{2} \cdot exp ( - \frac{‖ x - x ‖}{2 {l}^{2}} ) \qquad ( 1 )$$

The square exponential kernel function is:

$${k}_{SE} ( x , {x}^{′} ) = {σ}^{2} \cdot exp ( - \frac{{‖ x - x ‖}^{2}}{2 {l}^{2}} ) \qquad ( 2 )$$

The quadratic rational kernel function is:

$${k}_{RQ} ( x , {x}^{′} ) = 1 - \frac{{‖ x - x ‖}^{2}}{{‖ x - x ‖}^{2} - \text{?}} \\ \text{?} \text{indicates text missing or illegible when filed} \qquad ( 3 )$$

The Matérn kernel function is:

$$\text{?} ( x , {x}^{′} ) = \frac{{2}^{i - 1}}{\text{?} ( v )} {( \frac{\sqrt{2 v} ‖ x - x ‖}{l} )}^{v} {K}_{v} ( \frac{\sqrt{2 v} ‖ x - x ‖}{l} ) \\ \text{?} \text{indicates text missing or illegible when filed} \qquad ( 4 )$$

Where, σ denotes the vertical proportional parameter, dimensionless; exp(A) denotes the natural constant e to the power of A, with A denoting a constant or function; x and x′ denote two groups of data; l is the length proportional parameter, dimensionless; c denotes the intercept constant, dimensionless; ν denotes the smoothing factor, dimensionless; I′ denotes the gamma function; and Kν denotes the Bessel function.

It should be noted that the above four kernel functions are only commonly used, and other kernel functions in the prior art can also be used to establish Gaussian process regression model in the present invention.

Step 3: Calculate a covariance matrix and complete Gaussian process regression training with the training data sample based on a maximum likelihood estimation method to obtain the parameters of the kernel function and a Gaussian process regression model after the training is completed;

Preferably, Step 3 specifically includes the following sub-steps:

Step 301: Assume there is an implicit function ƒ(x) satisfying the functional relationship between the data x in the training data sample and the corresponding theoretical predicted gas volume y:

y=ƒ(x) (5)

Step 302: Calculate an initial covariance matrix with the training data sample based on the covariance matrix formula, the kernel function selected in Step 2 and the iterative initial value of the kernel function, where the covariance matrix formula is:

$$K = [ \begin{matrix}k ( {x}_{1} , {x}_{2} ) & k ( {x}_{1} , {x}_{2} ) & … & k ( {x}_{1} , {x}_{n} ) \\ k ( {x}_{2} , {x}_{2} ) & k ( {x}_{2} , {x}_{2} ) & … & k ( {x}_{2} , {x}_{n} ) \\ ⋮ & ⋮ & ⋱ & ⋮ \\ k ( {x}_{n} , {x}_{2} ) & k ( {x}_{n} , {x}_{2} ) & … & k ( {x}_{n} , {x}_{n} )\end{matrix} ] \qquad ( 6 )$$

Where, K denotes the covariance matrix calculated based on the kernel function; k denotes the kernel function; xᵢ(i=1,2 . . . . . . ,n) denotes the i^{th} group of data in the training data sample and n denotes the number of data groups in the training data sample;

Step 303: Perform a Gaussian process prior on the implicit function ƒ(x), and construct a Gaussian distribution relationship of the implicit function ƒ(x) according to the zero mean and the covariance matrix:

ƒ(x)=GP(O,K) (7)

Where, GP(φ, θ) denotes the Gaussian distribution, where P and 0 denote the mean and variance of the distribution, respectively;

Step 304: Calculate and obtain the theoretically predicted value of the gas 20 flow rate according to the Gaussian distribution relationship, iteratively optimize the parameters of the kernel function based on the maximum likelihood estimation method to obtain the kernel function parameters satisfying the maximum likelihood estimation, and calculate the covariance matrix under this optimized parameter;

Step 305: Obtain the optimized Gaussian distribution relationship according to the optimized covariance matrix, complete the training process of the Gaussian process regression model, and obtain the Gaussian process regression model after the training is completed.

Step 4: Test the Gaussian process regression model with the test data sample to calculate a prediction deviation;

Preferably, Step 4 specifically includes the following sub-steps:

Step 401: Establish a joint Gaussian prior distribution including the training data sample and the test data sample based on the Gaussian process regression model after the training is completed:

$$⌊ \begin{matrix}y \\ {y}^{′}\end{matrix} ⌋ : GP ( 0 , [ \begin{matrix}K & {( {K}^{*} )}^{T} \\ {K}^{*} & {K}^{**}\end{matrix} ] ) \qquad ( 8 )$$

Where, y* denotes the theoretically predicted gas flow rate corresponding to the test data sample, in 10⁴ m³/d; K* and K** denote the covariance matrix; T denotes the matrix transpose;

The covariance matrices K* and K** are respectively calculated by the following formulas:

$${K}^{*} = [ \begin{matrix}k ( {x}_{1}^{*} , {x}_{1} ) & k ( {x}_{1}^{*} , {x}_{2} ) & … & k ( {x}_{1}^{*} , {x}_{n} ) \\ k ( {x}_{2}^{*} , {x}_{1} ) & k ( {x}_{2}^{*} , {x}_{2} ) & … & k ( {x}_{2}^{*} , {x}_{n} ) \\ ⋮ & ⋮ & ⋱ & ⋮ \\ k ( {x}_{m}^{*} , {x}_{1} ) & k ( {x}_{m}^{*} , {x}_{2} ) & … & k ( {x}_{m}^{*} , {x}_{n} )\end{matrix} ] \qquad ( 9 )$$

$${K}^{**} = [ \begin{matrix}k ( {x}_{1}^{*} , {x}_{1}^{*} ) & k ( {x}_{1}^{*} , {x}_{2}^{*} ) & … & k ( {x}_{1}^{*} , {x}_{m}^{*} ) \\ k ( {x}_{2}^{*} , {x}_{1}^{*} ) & k ( {x}_{2}^{*} , {x}_{2}^{*} ) & … & k ( {x}_{2}^{*} , {x}_{m}^{*} ) \\ ⋮ & ⋮ & ⋱ & ⋮ \\ k ( {x}_{m}^{*} , {x}_{1}^{*} ) & k ( {x}_{m}^{*} , {x}_{2}^{*} ) & … & k ( {x}_{m}^{*} , {x}_{m}^{*} )\end{matrix} ] \qquad ( 10 )$$

Where, xⱼ*(j=1,2, . . . ,m) denotes the j^{th} group data in the test data sample; m denotes the number of data groups in the test data sample; if the kernel function marked with superscript symbol *, the data is corresponding to the test data sample; if without the superscript symbol *, the data is corresponding to the training data sample;

Step 402: Work out the posterior probability y* according to Bayesian regression method:

y′|X,y,K′:GP(K′K⁻¹y,K″−k′K⁻¹(K′)^{T}) (11)

Where, K⁻¹ denotes the inversion of the covariance matrix K;

Step 403: Take the distribution mean of the posterior probability as the theoretically predicted gas flow rate corresponding to the test data sample, compare the theoretically predicted gas flow rate with the actual gas flow rate of the test data sample, and calculate a prediction deviation.

Preferably, the prediction deviation is any one of mean square deviation, root mean square deviation, mean absolute deviation, and absolute value of mean relative deviation;

The mean square deviation is calculated by the following formula:

$$MSE = \frac{1}{N} {\sum }_{i = 1}^{N} {( {y}_{i , actual} - {y}_{i , predicted} )}^{2} \qquad ( 12 )$$

The root mean square deviation is calculated by the following formula:

$$RMSE = \sqrt{\frac{1}{N} {\sum }_{i = 1}^{N} {( {y}_{i , actual} - {y}_{i , predicted} )}^{2}} \qquad ( 13 )$$

The mean absolute deviation is calculated by the following formula:

$$MAE = \frac{1}{N} {\sum }_{i = 1}^{N} \vert {y}_{i , actual} - {y}_{i , predicted} \vert \qquad ( 14 )$$

The absolute value of the mean relative deviation is calculated by the following formula:

$$MARE = \frac{1}{N} {\sum }_{i = 1}^{N} \frac{\vert {y}_{i , actual} - {y}_{i , predicted} \vert}{{y}_{i , predicated}} \qquad ( 15 )$$

Where, N denotes the number of test data points, dimensionless; y_{i,predicted} denotes the theoretically predicted gas flow rate corresponding to the i^{th} group of test data sample, in 10⁴ m³/d; y_{i,actual} denotes the actual gas flow rate corresponding to the i^{th} group of test data sample, in 104 m³/d.

It should be noted that, in addition to the above four calculation methods for prediction deviation calculation, other calculation methods in the prior art can also be used to calculate the prediction deviation.

Step 5: Select different kernel functions, repeat Steps 2-4, compare prediction deviations of the different kernel functions, and preferably select the Gaussian process regression model with the minimum deviation;

Step 6: Analyze and predict the gas flow rate of the wellhead choke of the gas well to be tested according to the Gaussian process regression model with the minimum deviation.

The present invention has the following beneficial effects:

The present invention can achieve a higher accuracy in predicting the gas flow rate under the condition of gas-liquid two-phase flow in the wellhead choke than existing methods on the basis of ensuring easy field implementation, with broad application prospects in the analysis and prediction of gas well production and the study on gas-liquid two-phase flow of choke.

### BRIEF DESCRIPTION OF DRAWINGS

FIG. 1 is a schematic flow chart of a gas flow rate analysis and prediction method for wellhead choke of gas well based on Gaussian process regression;

FIG. 2 is a schematic diagram of the relationship between the theoretically predicted gas flow rate of the Gaussian process regression model (GPR-SE) established with the square exponential kernel function calculated in Embodiment 1 and the actual gas flow rate;

FIG. 3 is a schematic diagram of the relationship between the theoretically predicted gas flow rate of the Gaussian process regression model (GPR-Ex) established with the exponential kernel function calculated in Embodiment 1 and the actual gas flow rate;

FIG. 4 is a schematic diagram of the relationship between the theoretically predicted gas flow rate of the Gaussian process regression model (GPR-Ma) established with the Matérn kernel function calculated in Embodiment 1 and the actual gas flow rate;

FIG. 5 is a schematic diagram of the relationship between the theoretically predicted gas flow rate of the Gaussian process regression model (GPR-RQ) established with the quadratic rational kernel function calculated in Embodiment 1 and the actual gas flow rate.

### DETAILED DESCRIPTION OF THE EMBODIMENTS

The present invention is further described with reference to the drawings and embodiments. It should be noted that the embodiments in this application and the technical features in the embodiments can be combined with each other without conflict. It is to be noted that, unless otherwise specified, all technical and scientific terms herein have the same meaning as commonly understood by those of ordinary skill in the art to which this application belongs. “Include” or “comprise” and other similar words used in the present disclosure mean that the components or objects before the word cover the components or objects listed after the word and its equivalents, but do not exclude other components or objects.

### Embodiment 1

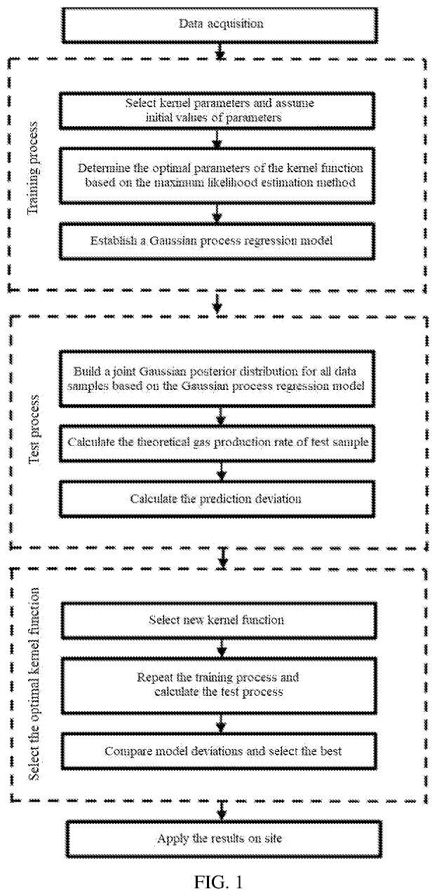

As shown in FIG. 1, a gas flow rate analysis and prediction method for wellhead choke of gas well based on Gaussian process regression, comprising the following steps:

Step 1: Acquire the basic data of the wellhead choke on site, obtain gas flow rate, produced liquid-gas ratio, choke diameter, wellhead temperature, and wellhead oil pressure at different moments, divide the gas flow rate, produced liquid-gas ratio, choke diameter, wellhead temperature and wellhead oil pressure at each moment are divided into one group, and then divide the total groups of data samples by training data sample and test data sample in a ratio of 9:1, with the results shown in Table 1:

TABLE 1
Basic Data of Wellhead Choke on Site

| Training data sample | | | | | | Test data sample | | | | | |
|---|---|---|---|---|---|---|---|---|---|---|---|
| | | | | | Actual | | | | | | Actual |
| | | Wellhead | | | gas flow | | | Wellhead | | | gas flow |
| | Choke | oil | Wellhead | Liquid- | rate at | | Choke | oil | Wellhead | Liquid- | rate at |
| | size | pressure | temperature | gas | wellhead | | size | pressure | temperature | gas | wellhead |
| S/N | mm | MPa | K | ratio | 10⁴ m³/d | S/N | mm | MPa | K | ratio | 10⁴ m³/d |
| 1 | 5.000 | 28.050 | 304.400 | 0.070 | 0.450 | 1 | 6.000 | 27.500 | 326.250 | 0.013 | 2.230 |
| 2 | 5.000 | 28.020 | 306.550 | 0.066 | 0.470 | 2 | 6.000 | 27.000 | 328.500 | 0.012 | 2.440 |
| 3 | 5.000 | 27.980 | 306.300 | 0.064 | 0.470 | 3 | 6.000 | 26.950 | 317.400 | 0.010 | 2.980 |
| 4 | 5.000 | 27.950 | 306.850 | 0.064 | 0.470 | 4 | 6.000 | 26.920 | 317.200 | 0.010 | 2.940 |
| 5 | 5.000 | 27.920 | 305.050 | 0.067 | 0.470 | 5 | 6.000 | 26.900 | 324.450 | 0.008 | 3.480 |
| 6 | 5.000 | 27.850 | 305.000 | 0.015 | 2.100 | 6 | 7.000 | 27.300 | 326.200 | 0.004 | 6.560 |
| 7 | 6.000 | 27.850 | 311.550 | 0.013 | 2.220 | 7 | 7.000 | 26.820 | 319.500 | 0.006 | 4.760 |
| 8 | 6.000 | 28.150 | 310.850 | 0.014 | 2.130 | 8 | 8.000 | 27.950 | 330.650 | 0.003 | 10.240 |
| 9 | 6.000 | 27.480 | 322.300 | 0.013 | 2.200 | 9 | 8.000 | 26.820 | 330.900 | 0.003 | 12.000 |
| 10 | 6.000 | 27.420 | 324.500 | 0.012 | 2.270 | 10 | 8.000 | 26.880 | 328.600 | 0.002 | 13.600 |
| 11 | 6.000 | 27.320 | 328.650 | 0.012 | 2.200 | 11 | 8.000 | 25.920 | 327.650 | 0.002 | 13.370 |
| 12 | 6.000 | 27.220 | 328.350 | 0.012 | 2.200 | 12 | 8.000 | 26.780 | 327.700 | 0.003 | 9.970 |
| 13 | 6.000 | 27.180 | 328.250 | 0.012 | 2.170 | 13 | 8.000 | 26.600 | 326.650 | 0.003 | 10.720 |
| 14 | 6.000 | 27.120 | 328.600 | 0.012 | 2.200 | 14 | 9.000 | 25.750 | 327.050 | 0.002 | 13.310 |
| 15 | 6.000 | 27.080 | 328.600 | 0.012 | 2.250 | 15 | 9.000 | 25.250 | 326.550 | 0.002 | 14.740 |
| 16 | 6.000 | 27.050 | 328.300 | 0.011 | 2.300 | 16 | 9.000 | 24.880 | 325.500 | 0.002 | 13.330 |
| 17 | 6.000 | 27.020 | 328.550 | 0.011 | 2.340 | 17 | 9.000 | 24.550 | 324.550 | 0.002 | 13.850 |
| 18 | 6.000 | 27.020 | 328.450 | 0.012 | 2.390 | 18 | 9.000 | 24.280 | 324.000 | 0.001 | 14.600 |
| 19 | 6.000 | 26.980 | 328.300 | 0.011 | 2.520 | 19 | 9.000 | 23.950 | 322.450 | 0.002 | 13.830 |
| 20 | 6.000 | 26.980 | 328.100 | 0.011 | 2.500 | 20 | 9.000 | 23.750 | 321.600 | 0.002 | 14.150 |
| 21 | 6.000 | 26.980 | 317.550 | 0.011 | 2.620 | 21 | 9.000 | 23.570 | 323.100 | 0.002 | 14.610 |
| 22 | 6.000 | 27.020 | 317.300 | 0.011 | 2.630 | 22 | 9.000 | 23.770 | 322.300 | 0.002 | 14.370 |
| 23 | 6.000 | 26.900 | 316.750 | 0.010 | 2.950 | 23 | 9.000 | 23.520 | 322.100 | 0.001 | 14.890 |
| 24 | 6.000 | 26.980 | 317.200 | 0.011 | 2.770 | 24 | 9.000 | 24.400 | 315.900 | 0.001 | 14.610 |
| 25 | 6.000 | 26.950 | 317.450 | 0.011 | 2.750 | 25 | 9.000 | 24.280 | 320.850 | 0.002 | 14.610 |

| | |
|---|---|
| . . . | . . . |

Note: As there are many basic data of the wellhead choke on site, only some data are listed in Table 1, where “ . . . ” indicates that there are unlisted data.

Step 2: Select the square exponential kernel function to establish Gaussian process regression models, and assume that the iterative initial values of the undetermined parameters of the square exponential kernel function, as shown in Table 2:

TABLE 2
Iterative Initial Value of Squared Exponential Kernel Function

| Kernel | Vertical proportional | Length proportional |
|---|---|---|
| function | parameter (σ) | parameter (l) |
| SE | 2.217 | 0.163 |

Step 3: Calculate a covariance matrix and complete Gaussian process regression training with the training data sample based on a maximum likelihood estimation method to obtain the parameters of the kernel function and a Gaussian process regression model after the training is completed; this step includes the following sub-steps:

(1) Work out the initial covariance matrix by calculation with training data samples according to the covariance matrix formula shown in Formula (6), the kernel function selected in Step 2, and the iterative initial value of the kernel function;
(2) Perform a Gaussian process prior on the implicit function ƒ(x), and construct a Gaussian distribution relationship of the implicit function ƒ(x) shown in Formula (7) according to the zero mean and the covariance matrix;
(3) Work out the theoretically predicted value of flow rate according to the Gaussian distribution relationship, with the results shown in Table 3:

TABLE 3
Theoretically Predicted Gas Flow Rates of Training Data
Samples Obtained by Square Exponential Kernel Function

| | Predicted gas flow rate of |
|---|---|
| S/N | training sample 104 m3/d |
| 1 | 0.598 |
| 2 | 0.538 |
| 3 | 0.402 |
| 4 | 0.667 |
| 5 | 0.543 |
| 6 | 2.215 |
| 7 | 2.234 |
| 8 | 2.227 |
| 9 | 2.306 |
| 10 | 2.252 |
| 11 | 2.247 |
| 12 | 2.226 |
| 13 | 2.255 |
| 14 | 2.237 |
| 15 | 2.227 |
| 16 | 2.407 |
| 17 | 2.288 |
| 18 | 2.273 |
| 19 | 2.392 |
| 20 | 2.569 |
| 21 | 2.698 |
| 22 | 2.713 |
| 23 | 2.999 |
| 24 | 2.749 |
| 25 | 2.693 |

. . .

(4) Iteratively optimize the parameters of the square exponential kernel function based on the maximum likelihood estimation method to obtain the kernel function parameters that satisfy the maximum likelihood estimation, with the results shown in Table 4:

TABLE 4
Iterative Final Value of Square Exponential Kernel Function

| Kernel | Vertical proportional | Length proportional |
|---|---|---|
| function | parameter (σ) | parameter (l) |
| SE | 7.502 | 0.341 |

(5) Calculate the optimized covariance matrix, and obtain optimized Gaussian distribution relationship based on the optimized covariance matrix, and complete Gaussian process regression training to obtain a Gaussian process regression model after the training is completed;

Step 4: Test the Gaussian process regression model with the test data sample to calculate a prediction deviation, specifically including the following sub-steps:

(1) Establish a joint Gaussian prior distribution including the training data sample and the test data sample based on the Gaussian process regression model after the training is completed;
(2) Work out the posterior probability y* according to Bayesian regression method;
(3) Take the distribution mean of the posterior probability as the theoretically predicted gas flow rate corresponding to the test data sample, and the calculation results are shown in Table 5:

TABLE 5
Theoretically Predicted Gas Flow Rates of Test Data Samples
Obtained by Square Exponential Kernel Function

| | Predicted gas flow rate of |
|---|---|
| S/N | test sample 10⁴ m³/d |
| 1 | 2.579 |
| 2 | 2.259 |
| 3 | 2.941 |
| 4 | 2.838 |
| 5 | 3.645 |
| 6 | 6.384 |
| 7 | 5.765 |
| 8 | 9.844 |
| 9 | 12.325 |
| 10 | 14.389 |
| 11 | 13.977 |
| 12 | 10.136 |
| 13 | 11.672 |
| 14 | 12.704 |
| 15 | 14.518 |
| 16 | 13.668 |
| 17 | 13.777 |
| 18 | 14.297 |
| 19 | 14.094 |
| 20 | 14.426 |
| 21 | 14.292 |
| 22 | 14.291 |
| 23 | 14.841 |
| 24 | 15.038 |
| 25 | 14.492 |

. . .

(4) Compare the theoretically predicted gas flow rate with the actual flow rate of the test data sample, and calculate the prediction deviation, with the results shown in Table 6:

TABLE 6
Prediction Deviation of GPR-SE Model

| Method | MSE | RMSE | MAE | MARE |
|---|---|---|---|---|
| GPR-SE | 1.073 | 1.036 | 0.609 | 0.211 |

Step 5: Select the exponential kernel function, Matérn kernel function and quadratic rational kernel function to establish Gaussian process regression models respectively, and repeat Steps 2-4 to obtain the prediction deviations of different kernel functions, with the results shown in Table 7:

TABLE 7
Prediction Deviations of Gaussian Process Regression
Models Established with Different Kernel Functions

| Method | MSE | RMSE | MAE | MARE |
|---|---|---|---|---|
| GPR-Ex | 0.532 | 0.730 | 0.442 | 0.134 |
| GPR-Ma | 0.796 | 0.892 | 0.557 | 0.160 |
| GPR-RQ | 0.563 | 0.750 | 0.467 | 0.139 |

Comparing the prediction deviations of the four different kernel functions in Table 6 and Table 7, and the GPR-Ex model with the smallest error in all models is selected as the final Gaussian process regression model;

Step 6: Analyze and predict the gas flow of the wellhead choke of the gas well to be tested according to the GPR-Ex with the minimum deviation.

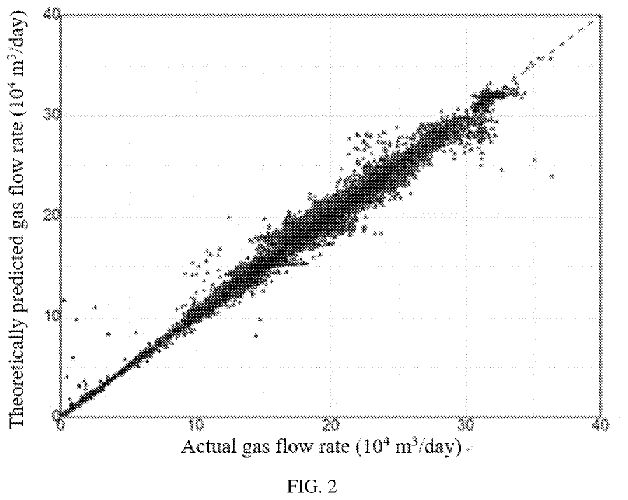

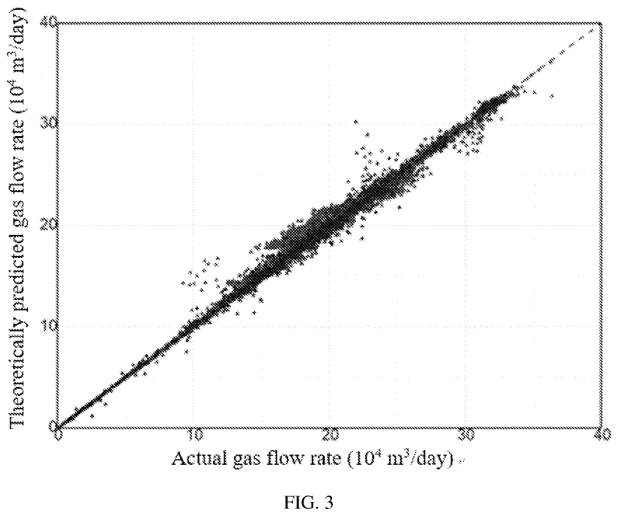

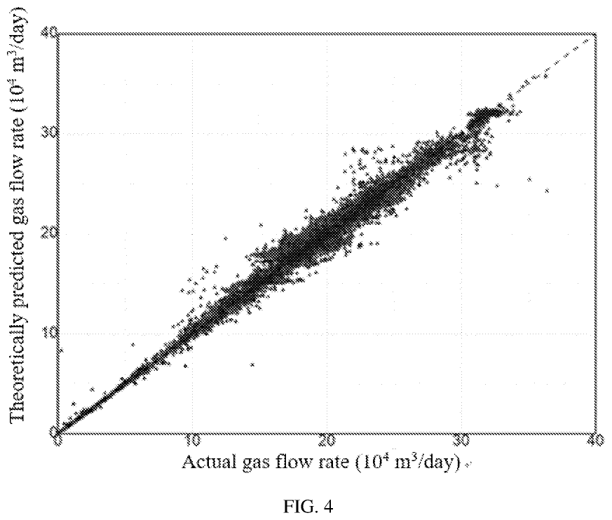

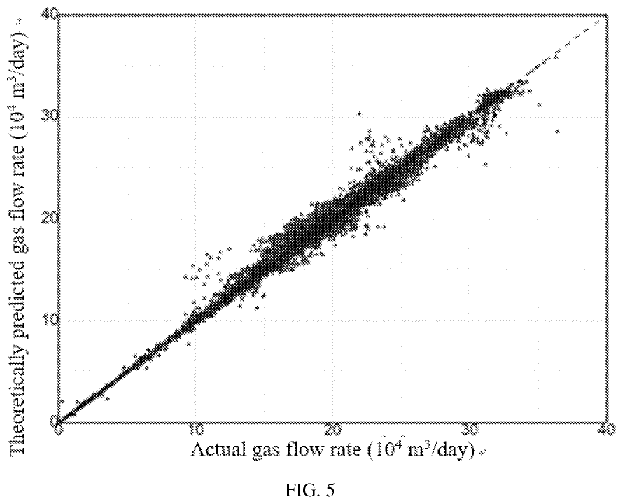

Take some known gas wells as the gas wells to be tested, predict the gas flow rate of the wellhead choke with the Gaussian process regression model established by each kernel function, and draw a diagram for the relationship between the theoretically predicted gas flow rate and the actual gas flow rate, as shown in FIG. 2-5. It can be seen from FIG. 2-5 that there is slight deviation between the theoretically predicted gas flow rate of the present invention and the actual gas flow rate, and the theoretically predicted gas flow rate obtained by the GPR-Ex model is the smallest in deviation and the highest in accuracy.

In addition, the gas flow analysis and prediction method of the present invention was compared with the prior art, with the results shown in Table 8:

TABLE 8
Prediction Deviations of Different Methods

| Method | MSE | RMSE | MAE | MARE |
|---|---|---|---|---|
| GC | 3.157 | 1.777 | 1.234 | 0.110 |
| ANN-BP | 1.997 | 1.413 | 0.973 | 0.221 |
| SVM-Gaussian | 1.143 | 1.069 | 0.691 | 0.167 |

Compared with Tables 6-8, it can be found that the deviation of the Gaussian process regression model of the present invention is smaller than that of the commonly used model, resulting in higher accuracy.

The above are not intended to limit the present invention in any form. Although the present invention has been disclosed as above with embodiments, it is not intended to limit the present invention. Those skilled in the art, within the scope of the technical solution of the present invention, can use the disclosed technical content to make a few changes or modify the equivalent embodiment with equivalent changes. Within the scope of the technical solution of the present invention, any simple modification, equivalent change and modification made to the above embodiments according to the technical essence of the present invention are still regarded as a part of the technical solution of the present invention.

What is claimed is:

1. A gas flow rate analysis and prediction method for wellhead choke of gas well based on Gaussian process regression, comprising the following steps:
Step 1: Acquire basic data of the wellhead choke on site and dividing them into training data samples and test data samples; the basic data of the wellhead choke on site includes gas flow rate at different moments, produced liquid-gas ratio, choke diameter, wellhead temperature, and wellhead oil pressure; the gas flow rate, produced liquid-gas ratio, choke diameter, wellhead temperature and wellhead oil pressure at each moment are divided into one group; the number of groups of the training data samples is greater than that of the test data samples;
Step 2: Select a kernel function and assume an iterative initial value of an undetermined parameter of the kernel function;
Step 3: Calculate a covariance matrix and complete Gaussian process regression training with the training data sample based on a maximum likelihood estimation method to obtain the parameters of the kernel function and a Gaussian process regression model after the training is completed;
Step 4: Test the Gaussian process regression model with the test data sample to calculate a prediction deviation;
Step 5: Select different kernel functions, repeat Steps 2-4, compare prediction deviations of the different kernel functions, and preferably select the Gaussian process regression model with the minimum deviation;
Step 6: Analyze and predict the gas flow rate of the wellhead choke of the gas well to be tested according to the Gaussian process regression model with the minimum deviation.

2. The gas flow rate analysis and prediction method for wellhead choke of gas well based on Gaussian process regression according to claim 1, wherein the gas flow rate refers to the volume flow rate of the gas flowing through the wellhead choke under standard conditions; the produced liquid-gas ratio refers to the ratio of the liquid flow rate to the volume flow rate of the gas flowing through the wellhead choke under standard conditions.

3. The gas flow rate analysis and prediction method for wellhead choke of gas well based on Gaussian process regression according to claim 1, wherein the ratio of the number of sample groups of training data to the number of sample groups of test data is 6-9:4-1.

4. The gas flow rate analysis and prediction method for wellhead choke of gas well based on Gaussian process regression according to claim 1, wherein the kernel function refers to any one of exponential kernel function, square exponential kernel function, quadratic rational kernel function, and Matérn kernel function;
The exponential kernel function is:
$${k}_{Ex} ( x , {x}^{′} ) = {σ}^{2} \cdot exp ( - \text{?} )$$
$$\text{?} \text{indicates text missing or illegible when filed}$$
The square exponential kernel function is:
$${k}_{SE} ( x , {x}^{′} ) = {σ}^{2} \cdot exp ( - \text{?} )$$
$$\text{?} \text{indicates text missing or illegible when filed}$$
The quadratic rational kernel function is:
$$\begin{matrix}{k}_{RQ} ( x , {x}^{′} ) = 1 - \frac{{‖ x - x ‖}^{2}}{{‖ x - x ‖}^{2} - \text{?}} & \end{matrix}$$
$$\text{?} \text{indicates text missing or illegible when filed}$$
The Matérn kernel function is:
$$\text{?}$$
$$\text{?} \text{indicates text missing or illegible when filed}$$
Where, σ denotes the vertical proportional parameter, dimensionless; exp(A) denotes the natural constant e to the power of A, with A denoting a constant or function; x and x′ denote two groups of data; I is the length proportional parameter, dimensionless; c denotes the intercept constant, dimensionless; ν denotes the smoothing factor, dimensionless; Γ denotes the gamma function; and Kν denotes the Bessel function.

5. The gas flow rate analysis and prediction method for wellhead choke of gas well based on Gaussian process regression according to claim 1, wherein Step 3 specifically includes the following sub-steps:
Step 301: Assume there is an implicit function ƒ(x) satisfying the functional relationship between the data x in the training data sample and the corresponding theoretical predicted gas volume y:
y=ƒ(x)
Step 302: Calculate an initial covariance matrix with the training data sample based on the covariance matrix formula, the kernel function selected in Step 2 and the iterative initial value of the kernel function, where the covariance matrix formula is:
$$K = [ \begin{matrix}k ( {x}_{1} , {x}_{1} ) & k ( {x}_{1} , {x}_{2} ) & … & k ( {x}_{1} , {x}_{n} ) \\ k ( {x}_{2} , {x}_{1} ) & k ( {x}_{2} , {x}_{2} ) & … & k ( {x}_{2} , {x}_{n} ) \\ ⋮ & ⋮ & ⋱ & ⋮ \\ k ( {x}_{n} , {x}_{1} ) & k ( {x}_{n} , {x}_{2} ) & … & k ( {x}_{n} , {x}_{n} )\end{matrix} ]$$
Where, K denotes the covariance matrix calculated based on the kernel function; k denotes the kernel function; xᵢ(i=1,2 . . . . . . ,n) denotes the i^{th} group of data in the training data sample and n denotes the number of data groups in the training data sample;
Step 303: Perform a Gaussian process prior on the implicit function ƒ(x), and construct a Gaussian distribution relationship of the implicit function ƒ(x) according to the zero mean and the covariance matrix:
ƒ(x)=GP(O:K)
Where, GP(φ, θ) denotes the Gaussian distribution, where p and 0 denote the mean and variance of the distribution, respectively;
Step 304: Calculate and obtain the theoretically predicted value of the gas flow rate according to the Gaussian distribution relationship, iteratively optimize the parameters of the kernel function based on the maximum likelihood estimation method to obtain the kernel function parameters satisfying the maximum likelihood estimation, and calculate the covariance matrix under this optimized parameter;
Step 305: Obtain the optimized Gaussian distribution relationship according to the optimized covariance matrix, complete the training process of the Gaussian process regression model, and obtain the Gaussian process regression model after the training is completed.

6. The gas flow rate analysis and prediction method for wellhead choke of gas well based on Gaussian process regression according to claim 5, wherein Step 4 includes the following sub-steps:
Step 401: Establish a joint Gaussian prior distribution including the training data sample and the test data sample based on the Gaussian process regression model after the training is completed:
$$[ \begin{matrix}y \\ {y}^{′}\end{matrix} ] : GP ( 0 , [ \begin{matrix}K & {( {K}^{′} )}^{T} \\ {K}^{′} & {K}^{″}\end{matrix} ] )$$
Where, y* denotes the theoretically predicted gas flow rate corresponding to the test data sample, in 10⁴ m³/d; K* and K** denote the covariance matrix; T denotes the matrix transpose;
The covariance matrices K* and K** are respectively calculated by the following formulas:
$${K}^{′} = [ \begin{matrix}k ( {x}_{1}^{′} , {x}_{1} ) & k ( {x}_{1}^{′} , {x}_{2} ) & … & k ( {x}_{1}^{′} , {x}_{n} ) \\ k ( {x}_{2}^{′} , {x}_{1} ) & k ( {x}_{2}^{′} , {x}_{2} ) & … & k ( {x}_{2}^{′} , {x}_{n} ) \\ ⋮ & ⋮ & ⋱ & ⋮ \\ k ( {x}_{m}^{′} , {x}_{1} ) & k ( {x}_{m}^{′} , {x}_{2} ) & … & k ( {x}_{m}^{′} , {x}_{n} )\end{matrix} ]$$
$${K}^{″} = [ \begin{matrix}k ( {x}_{1}^{′} , {x}_{1}^{′} ) & k ( {x}_{1}^{′} , {x}_{2}^{′} ) & … & k ( {x}_{1}^{′} , {x}_{m}^{′} ) \\ k ( {x}_{2}^{′} , {x}_{1}^{′} ) & k ( {x}_{2}^{′} , {x}_{2}^{′} ) & … & k ( {x}_{2}^{′} , {x}_{m}^{′} ) \\ ⋮ & ⋮ & ⋱ & ⋮ \\ k ( {x}_{m}^{′} , {x}_{1}^{′} ) & k ( {x}_{m}^{′} , {x}_{2}^{′} ) & … & k ( {x}_{m}^{′} , {x}_{m}^{′} )\end{matrix} ]$$
Where, x* j (j=1,2, . . . ,m) denotes the j group data in the test data sample; m denotes the number of data groups in the test data sample; if the kernel function marked with superscript symbol * the data is corresponding to the test data sample; if without the superscript symbol *, the data is corresponding to the training data sample;
Step 402: Work out the posterior probability y* according to Bayesian regression method:
y′|X,y,X′:GP(K′K⁻¹y,K″−K′K⁻¹(K′)^{T})
Where, K⁻¹ denotes the inversion of the covariance matrix K;
Step 403: Take the distribution mean of the posterior probability as the theoretically predicted gas flow rate corresponding to the test data sample, compare the theoretically predicted gas flow rate with the actual gas flow rate of the test data sample, and calculate a prediction deviation.

7. The gas flow rate analysis and prediction method for wellhead choke of gas well based on Gaussian process regression according to claim 6, wherein the prediction deviation is any one of mean square deviation, root mean square deviation, mean absolute deviation, and absolute value of mean relative deviation;
The mean square deviation is calculated by the following formula:
$$MSE = \frac{1}{N} {\sum }_{i = 1}^{N} {( {y}_{i , actual} - {y}_{i , predicted} )}^{2}$$
The root mean square deviation is calculated by the following formula:
$$RMSE = \sqrt{\frac{1}{N} {\sum }_{i = 1}^{N} {( {y}_{i , actual} - {y}_{i , predicted} )}^{2}}$$
The mean absolute deviation is calculated by the following formula:
$$MAE = \frac{1}{N} {\sum }_{i = 1}^{N} \vert {y}_{i , actual} - {y}_{i , predicted} \vert$$
The absolute value of the mean relative deviation is calculated by the following formula:
$$MARE = \frac{1}{N} {\sum }_{i = 1}^{N} \frac{\vert {y}_{i , actual} - {y}_{i , predicted} \vert}{{y}_{i , predicated}}$$
Where, N denotes the number of test data points, dimensionless; y_{i,predicted} denotes the theoretically predicted gas flow rate corresponding to the i^{th} group of test data sample, in 10⁴ m³/d; y_{i,actual} denotes the actual gas flow rate corresponding to the i^{th} group of test data sample, in 10⁴ m³/d.
